(19) United States
(12) Patent Application Publication
(10) Pub. No.: US 2024/0060734 A1
(43) Pub. Date: Feb. 22, 2024

(54) SYSTEMS, DEVICES, AND METHODS FOR A SMART THERMAL AND DETECTION SYSTEM

(71) Applicant: Oqab Dietrich Induction Inc., Kitchener (CA)

(72) Inventors: Haroon B. Oqab, Kitchener (CA); George B. Dietrich, Kitchener (CA)

(21) Appl. No.: 18/260,328

(22) PCT Filed: Jan. 4, 2022
(86) PCT No.: PCT/CA2022/050004

§ 371 Date: Jul. 4, 2023

Related U.S. Application Data
(60) Provisional application No. 63/133,748, filed on Jan. 4, 2021.

(51) Int. Cl. F28F 13/18; C06B 33/00

(52) U.S. Cl. CPC F28F 13/18; C06B 33/00; F28F 2245/06

(57) ABSTRACT

Provided are systems, devices, and methods for a smart thermal control. The thermal control system may include an energy source, a first deposit of energetic particles having an inherent Curie temperature, and at least one heat receiving object. Upon application of energy from the energy source to the first deposit of energetic particles the energetic particles are heated and can transfer heat to the at least one heat receiving object. The temperature of the first deposit can be controlled by the application of energy to be heated to various specific temperatures up to the Curie temperature. Applications including de-icing, ice prevention, cooking, medical devices, ignition systems and autonomous vehicles, as well as applications in space, are discussed.

### TECHNICAL FIELD

The embodiments disclosed herein relate to heating of objects, and, in particular to heating objects to a specific temperature using energetic multi-dimensional particles, surfaces and materials.

### INTRODUCTION

Energetic particles, including nanoenergetic or microenergetic particles, are metastable intermolecular composites, typically made of metals, metal oxides and or halogen composites which can be used to create heat, electricity, and/or thrust. The metals in these particles have high energy densities and can be used in batteries, energetic materials, and/or propellants. Energetic particles have a combustion temperature wherein heating of the particles to the combustion temperature results in a exothermic reaction between the metal and an oxidizer releasing heat and generating thrust, heat, electricity and thermal power generation.

Energetic particles have a Curie temperature, which is a temperature at which energetic particles undergo a change in their magnetic properties. At the Curie temperature a magnetic material lose their magnetic properties. Materials heated to the Curie Temperature exhibit a thermal equilibrium where a uniform temperature distribution is achieved in the particles. Additional input of electromagnetic energy achieves minimal temperature fluctuations, and the particles stay below the combustion temperature around the Curie temperature. The Curie temperature can be used in heating applications of energetic particles (e.g., nanoenergetic particles) for thermal regulation. That is, energetic particles can be thermally regulated using temperatures up to the Curie temperature for heating and power generation applications, for example, inductive heating. Increasing the energy is applied to the energetic particles such that the energetic particles are heated beyond the Curie temperature to reach the combustion temperature, energetic particles may also be used in other heating and or propulsive and/or power generation applications.

An example of an energetic particle having a Curie temperature is a thermite. Different compositions of thermites have different Curie temperatures and can be caused to output heat at specified temperatures up to the Curie temperature. The present systems, devices, and methods exploit the Curie temperature characteristics of the energetic particles described herein, including surfaces and materials on the micro and nanoscale (nanothermites), to provide thermal control systems and various embodiments thereof.

### SUMMARY

A thermal control system including an energy source, at least a first deposit of energetic particles having an inherent Curie temperature, wherein upon application of the energy source to the first deposit of energetic particles the energetic particles produce heat, and at least one heat receiving object, wherein the at least a first deposit of energetic particles transfer heat to the at least one heat receiving object to achieve a desired effect.

The energetic particles may be chosen from a group consisting of: metastable intermolecular combustibles, thermites, nanothermites, microthermites, a composition of nanothermites and microthermites, nanoenergetic particles, and nanoenergetic materials or the like.

The energetic particles may include a metal and an oxidizer. The metal may be chosen from a group consisting of: aluminum, magnesium, silicon, lithium, boron, and iron. The oxidizer may be chosen from a group consisting of: air, water, metal oxides and/or halogen composites or the like.

The energetic particles of the first deposit may be homogenous or heterogenous. Where the particles may be heterogeneous the composition of the heterogeneous energetic particles determines the Curie temperature of the first deposit.

The desired effect of the thermal control system may be a physical reaction at the at least one heat receiving object.

The desired effect may be a chemical reaction at the at least one heat receiving object.

The desired effect may be a change in a structure of the at least one heat receiving object.

The first deposit of energetic particles may be a layer on a surface of a body. The layer of energetic particles comprises a thermally optimized geometric pattern. The body may be the at least a first heat receiving object or the at least a first heat receiving object may contact the surface of the body.

The first deposit of energetic particles may be embedded within a body. The first deposit of energetic particles may be embedded within the at least a first heat receiving object.

The first deposit of energetic particles may comprise a body. The body may include at least one cylinder.

The system may further comprise a second deposit of energetic particles. The second deposit of energetic particles may have a different Curie temperature than the first deposit of energetic particles. The second deposit of energetic particles may have the same Curie temperature as the first deposit of energetic particles.

The first deposit may include a first ring on a surface of a body and the second deposit may comprise a second ring on the surface of the body wherein the second ring contains the first ring.

The energy may be applied to the second deposit of energetic particles separately from the first deposit of thermite particles. The energy may be applied to the first deposit of energetic particles and the second deposit of energetic particles simultaneously.

The at least a first deposit of energetic particles may include a plurality of layers of energetic particles.

The energy source may apply a magnetic field to the at least a first deposit of energetic particles.

The energy source may comprise at least one electromagnetic coil positioned proximate the at least a first deposit of energetic particles.

The energy source may produce electromagnetic radiation chosen from a group consisting of: laser radiation, maser radiation, microwaves, millimetre waves, terahertz, and infrared light or the like.

The energy source may be at least one magnet.

The energy source may be at least one electromagnet.

The at least a first deposit of energetic particles may comprise a three-dimensional structure.

The at least a first deposit of energetic particles may heat the at least a first heat receiving object volumetrically.

A plurality of deposits of energetic particles may comprise a plurality of cylinders and the at least a first heat receiving object may comprise a fluid, wherein the fluid flows past the cylinders and may be heated by convection. The plurality of cylinders may be hollow and the fluid may flow through the cylinders.

The at least a first deposit of energetic particles may be at least partially coated with a catalyst.

Each energetic particle may be less than 100 nanometres in size. Each energetic particle may be less than 100 micrometres in size. Each energetic particle may be between 10 and 100 micrometres in size. Each energetic particle may be equal to or greater than 100 micrometres in size.

The at least a first deposit of thermite particles may include thermite particles of different sizes.

The system may be used for de-icing.

The system may be used for ablation.

The first deposit of energetic particles may be embedded in mixtures such as concrete or other pastes, slurry and/or aggregates or the like.

The system may further include an autonomous vehicle which carries the energy source and the at least a first deposit of thermite particles to the at least a first heat receiving object to transfer heat to the at least a first heat receiving object.

The system may further include a thermite particle depositing subsystem wherein the at least a first deposit of thermite particles may be deposited on a surface of the at least a first heat receiving object by the energetic particle depositing subsystem.

The at least a first deposit of energetic particles may be deposited on a wheel of a vehicle.

The at least a first deposit of energetic particles may be embedded within a surface and or a material.

The energy source may comprise an outer layer of a body and the at least one deposit of energetic particles may comprise an inner layer of the body wherein the body further includes an interior within the inner layer in which the at least one heat receiving body can be placed to receive heat from the energetic particles.

The first deposit of energetic particles may be heated up to the Curie temperature for a heating application.

The first deposit of energetic particles may be heated to a combustion temperature of the first deposit of for a combustive application.

The first deposit of energetic particles may be heated to a combustion temperature of the first deposit of for a construction application.

The first deposit of energetic particles may be heated to a specific temperature of the first deposit of for a detection application.

The combustive application may be chosen from a group consisting of: propulsion and power generation.

The system may be used for medical application and/or procedures.

A method of controlled heating of an object may include heating at least a first deposit of energetic particles by applying energy from an energy source to the at least a first deposit of energetic particles, wherein the first deposit of energetic particles has a Curie temperature, and transferring heat from the at least a first deposit of energetic particles to the object to achieve a desired effect.

The desired effect may occur at temperatures up to the Curie temperature of the first deposit of energetic thermite particles.

The desired effect may be a chemical reaction, a physical reaction, thermal, electromagnetic, magnetic and/or a change in structure of the object.

The desired effect may occur at a specific temperature to receiving and or transmitting electromagnetic radiation and or particles by the heated energetic particles.

The desired effect may be melting ice or preventing ice formation or controlling viscosity or surface tension in a particle, surface and/or material.

The desired effect may occur at a combustion temperature above the Curie temperature.

Transferring heat from the at least a first deposit of energetic particles to the object may include volumetric heating.

Applying energy from the energy source to the at least a first deposit of energetic particles may include applying a magnetic field to the at least a first deposit of energetic particles.

Applying energy from the energy source to the at least a first deposit of energetic particles may include induction.

The energy source may produce electromagnetic radiation chosen from a group consisting of: laser radiation, maser radiation, microwaves, millimeter waves, terahertz, and infrared light or the like.

The energy source may be at least one magnet or electromagnet.

### BRIEF DESCRIPTION OF THE DRAWINGS

The drawings included herewith are for illustrating various examples of articles, methods, and apparatuses of the present specification. In the drawings:

FIG. 1 is a block diagram of a thermal control system, according to one embodiment.

FIG. 2 is a block diagram of a thermal control system, according to one embodiment.

FIG. 3 is a block diagram of a thermal control system, according to one embodiment.

FIG. 4 is a flow diagram of a method of using a thermal control system to achieve a desired effect, according to one embodiment.

FIG. 5 is a perspective view of two deposit of energetic particles for use in a thermal control system, according to one embodiment.

FIG. 6a is block diagram of a configuration for a structure comprising a plurality of energy sources and a body comprising a plurality of deposits of energetic particles, according to one embodiment.

FIG. 6b is a top view of the structure and body of FIG. 6b, according to one embodiment.

FIG. 7 is a block diagram of an energy source and a deposit of energetic particles embedded within concrete, according to one embodiment.

FIG. 8 is a perspective view of a plurality of deposits of thermite particles in the shape of cylinders within a box for use in a thermal control system employing volumetric heating, according to one embodiment.

FIG. 9 is a block diagram of a thermal control system for use in de-icing an object, according to one embodiment.

FIG. 10 is a block diagram of a thermal control system wherein energetic particles are deposited directly onto a heat receiving object, according to one embodiment.

FIG. 11 is a block diagram of a thermal control system using a Halbach array configuration, according to one embodiment.

FIG. 12 is a block diagram of a thermal control system being used to charge an electric vehicle, according to one embodiment.

FIG. 13 is a block diagram of a thermal control system on a spacecraft for use with applications in space, according to one embodiment.

FIG. 14 is a block diagram of a thermal control system on a satellite for use with applications in space, according to one embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

The present systems, devices, and methods for thermal control systems employ energetic particles to create heat within a system. The energetic particles may be nano- and/or micro-energetic particle, such as thermites which are intermolecular composites of a metal and a metal oxide. Energetic particles may be composed of metals such as aluminum, magnesium, silicon, lithium, boron, iron, and an oxidizer, including metal oxides and halogen composites. Energetic particles may also include halogen composites. Herein, the thermites discussed generally include nanothermites or nanoenergetic materials with particle sizes under 100 nm, but may include thermites with a particle size above 100 nm. Reference to “nanothermites” herein is meant to include any energetic particles (not just thermites) with a particle size (or particle sizes in the case of a heterogeneous composition) up to 100 nm as well as particle sizes on the microscale and above unless explicitly stated otherwise.

It is to be understood that any specific reference to an energetic particle, energetic material, nanoenergetic particle, nanoenergetic material, nanothermite, microthermite, nanothermite particles, thermites, metastable intermolecular combustibles (MICs) and/or compositions therein, is exemplary and that in embodiments any particles or materials discussed herein could be used in the place of any other particles or materials discussed herein.

Herein, the composition of any nanothermite deposit (energetic particle deposit) discussed may be homogeneous and include only one type of nanothermite or may be a heterogenous deposit which includes multiple types of nanothermites. Where multiple deposits are discussed within the same system, each deposit may be homogeneous or heterogeneous and each deposit may have the same or different composition from each other deposit.

Herein, any configuration of nanothermite particles, for example a layer on a surface and or in a material, particles embedded in another material, such as coreshell nanothermites particles in a material or a three-dimensional body of nanothermite particles such as a cylinder, is referred to as a “deposit of nanothermite particles” or a “deposit”.

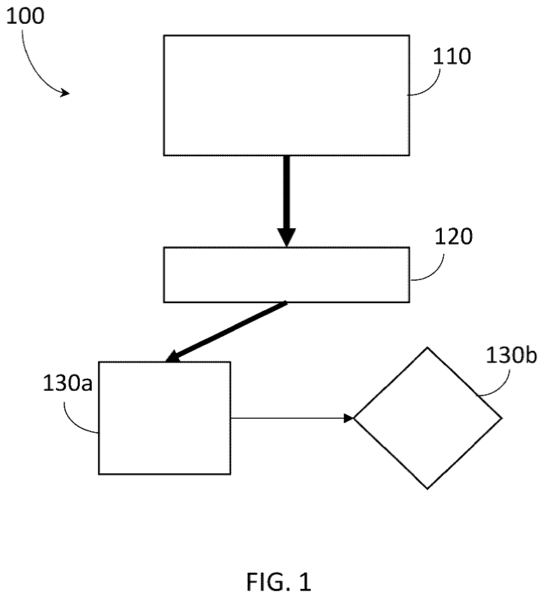

Referring to FIG. 1, illustrated therein, as a block diagram, is a thermal control system 100. The thermal control system 100 includes an energy source 110, a deposit of nanothermite particles 120, and a heat receiving object 130a/b.

The energy source 110 produces any type of energy which is capable of being applied to the deposit of nanothermite particles 120 to cause the nanothermite particles to produce heat. For example, the energy source 100 may produce a laser, a maser, infrared light, terahertz, millimeter waves, microwaves, or any other energy which can act on the nanothermite particles 120 electromagnetically. The energy source may be a permanent magnet or magnets which can act upon the nanothermite particles when brought close to the nanothermite particles using magnetic induction, for example, the energy source may be a system which resembles a Halbach array. The magnetic field created by the energy source may be unidirectional or multi-directional.

When the energy source 110 produces energy which is directed at the nanothermite particles (arrow between 110 and 120 in FIG. 1) the nanothermite particles create heat which can be transferred to the heat receiving object 130a (transfer represented by the arrow between 120 and 130a in FIG. 1).

The transfer of heat from the nanothermite particles 120 to the heat receiving object 130 produces a desired effect, for example a chemical reaction or a physical reaction. In FIG. 1, the desired effect is a structural change to the shape of object 130a which results in the shape shown at 130b.

However, in some embodiments, the desired effect only occurs at a specific temperature. An inherent property of nanothermite particles is that they have a Curie temperature which is reached upon application of electromagnetic energy to the particles. By altering the magnetic field of the nanothermite particles by application of the electromagnetic energy, a range of temperatures up to the Curie temperature may be realized for thermal control and/or for receiving and or transmitting electromagnetic radiation and or particles by the heated energetic particles. The nanothermite particles will maintain a uniform heat distribution at the Curie temperature even if further electromagnetic energy is applied (as long as the continued application of electromagnetic energy remains below a threshold which would cause combustion).

For example, if the Curie temperature of a deposit of nanothermite particles is 300° C., the nanothermite particles can be heated up to 300° C. for use, when enough electromagnetic energy is applied. Once the Curie temperature is reached the nanoparticles will not heat past 300° C. if an excess of electromagnetic energy is applied. Therefore, the nanothermite particles can be used to control the temperature of a system. Depending on the material, the Curie temperature can be a low or high temperature and therefore can be used in systems which require low temperatures for heating or high temperatures for heating as discussed in “Induction heating of dispersed metallic particles in a turbulent flow” by Drs. Joseph Mouallem and Jean-Pierre Hickey (International Journal of Multiphase Flow, July 2020), which is incorporated by reference herein in its entirety.

As an example of a desired effect, a chemical reaction may occur at 40° C. and therefore a nanothermite with a Curie temperature of 41° C. may be chosen for a thermal control system such that when the Curie temperature of 41° C. is maintained the chemical reaction is guaranteed to occur. The energy source may be tunable such that the energy applied can be lowered to cause the nanothermite deposit of the thermal control system to have a temperature of 38° C. The amount of energy applied can be altered such that the temperature switches back a forth between 38° C. and 41° C. effectively turning the chemical reaction off and on.

In some embodiments, the electromagnetic energy applied of the nanothermite deposit may be varied to alter the magnetic field of the deposit to achieve temperatures that are below the Curie temperature. Therefore, the electromagnetic energy from the energy source may be tunable such that the temperature of the nanothermite deposit is tunable up to the Curie temperature. As long as the applied energy does cannot act to increase the temperature of the nanothermite deposit to a combustion temperature of the nanothermite deposit the Curie temperature of the nanothermite deposit is maintained. Various types of nanothermites or heterogeneous compositions of nanothermites have different Curie temperatures. This characteristic of nanothermites/mixed nanothermites can be exploited to create thermal control systems which can perform work (e.g., chemical reactions, physical reactions, thermal, electromagnetic, magnetic and/or structural changes of an object) which requires a specific temperature to be achieved.

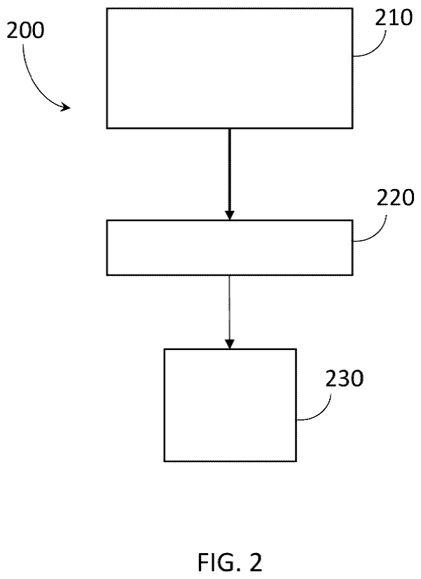

FIG. 2 is a block diagram of a thermal control system 200, according to one embodiment. FIG. 2 represents the same thermal control system as FIG. 1 and includes energy source 210, deposit of nanothermite particles 220, and heat receiving object 230. Illustrated in FIG. 2 is a scenario in which the amount of energy applied to the nanothermite particles 220 by the energy source 210 is less than that in FIG. 1 (represented by the arrow between 210 and 220 being smaller than the arrow between 110 and 120 in FIG. 1). The amount of energy which is applied to the nanothermite particles 220 is not enough for the heat produced by the nanothermite particles 220 and transferred to the heat receiving object 230 to produce the desired effect. Therefore, heat receiving object 230 does not change its shape because the temperature at which the structural change would occur has not been reached. In other implementations, represents the same thermal control system as FIG. 1 and includes energy source 210, deposit of nanothermite particles 220, and heat receiving object 230, whereas the electromagnetic and/or magnetic properties of the heat receiving object 230 are altered for reducing and/or amplifying electromagnetic energy to produce the desired effect.

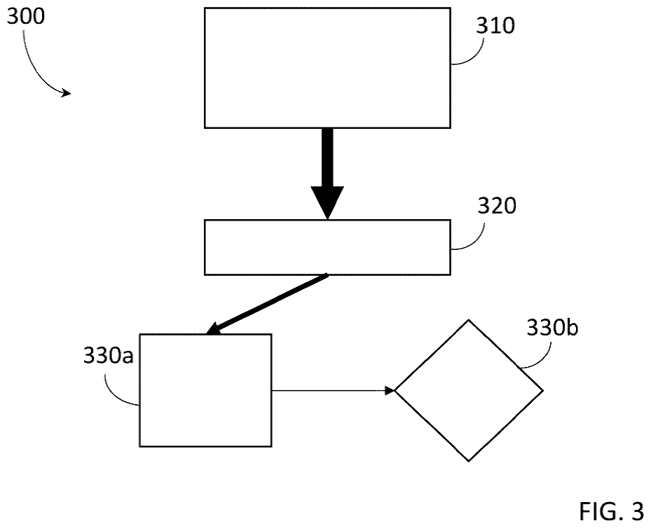

FIG. 3 is a block diagram of a thermal control system 300, according to one embodiment. FIG. 3 represents the same thermal control system as FIGS. 1 and 2 and includes energy source 310, deposit of nanothermite particles 320, and heat receiving objects 330a/b. The amount of energy which is applied to the nanothermites particles 320 by energy source 310 is more than the energy which was applied in FIG. 1 to nanothermite particles 120 by energy source 110 (represented by the arrow between 310 and 320 being larger than the arrow between 110 and 120 in FIG. 1). However, the heat which is transferred from the nanothermite particles 320 to the heat receiving object 330a is the same as in FIG. 1 because the nanothermite particles 320 cannot be heated past the Curie temperature of the nanothermite particles 320. The heat receiving object 300a changes shape to 330b as the required temperature for the structural change to occur has been achieved.

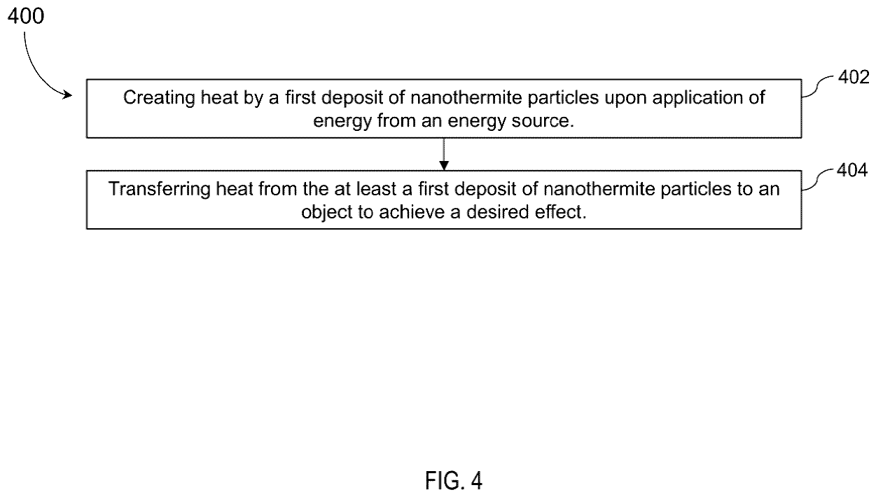

FIG. 4 is a flow diagram of a method 400 of using a thermal control system to achieve a desired effect, according to one embodiment. The thermal control system includes an energy source, at least a first deposit of nanothermite particles, and an object to receive heat.

At 402, the first deposit of nanothermite particles creates heat upon application of energy from the energy source. The energy source may be any source which can create electromagnetic radiation or a magnetic field which can be applied to the first deposit to activate the nanothermite particles to create heat.

At 404, the heat created by the first deposit of nanothermite particles is transferred to an object to achieve a desired effect. The desired effect may be a chemical reaction, a physical reaction, thermal, electromagnetic, magnetic or a structural change. The desired effect may be generating electricity by converting heat to electricity using thermophotovoltaics.

Where the desired effect is a chemical reaction, the chemical reaction will be an endothermic reaction which requires heat to occur. The chemical reaction may only occur at a specific temperature and the Curie temperature of the first deposit of nanothermite particles may be at that specific temperature or higher such that the reaction can be maintained at the temperature and controlled by turning on or off the energy source. In this way the thermal control system acts a switch to turn on or off a reaction.

An example of a physical reaction is melting ice which is discussed herein for various embodiments of de-icing or ice prevention. Broader examples of physical reactions may include temperature changes and/or phase changes (e.g., solid to liquid, liquid to gas, solid to gas, etc.).

An example of a structural change would be changing the shape of an object wherein the phase/state of matter of the object does not otherwise change (e.g., no change of state from solid to fluid as would occur with melting ice) as shown in FIG. 1. For example, the object may shrink or grow in size.

An example of a thermal change would be heating a surface of energetic particles to create heat, wherein the waste heat is harvested using thermophotovoltaics for electrical and or thermal power generation.

An example of an electromagnetic and or magnetic change would be the heating to a specific temperature to alter the electromagnetic and or magnetic properties of a nanoenergetic particle on surface or material for detection purposes for example the nanothermite may be embedded in a surface or material and used as a identifier (imprint of qr code, barcode, picture, numbers and/or letter or the like) using an electromagnet and or a magnet. In other examples, magnets and electromagnets can be used to locally alter the electromagnetic and or magnetic properties by altering the magnetic fields and heating energetic particles on the surface of and or inside the human body for medical applications.

Additional steps in the method are discussed in the various embodiments of a thermal control system discussed herein.

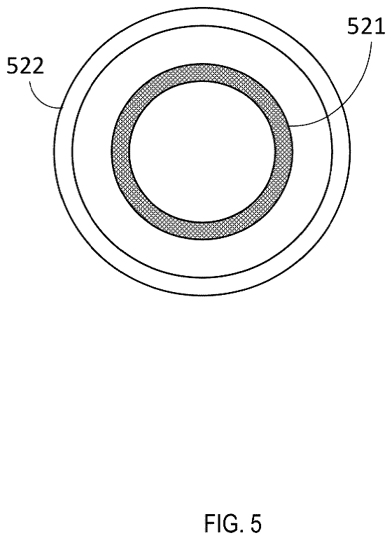

FIGS. 5-14 show various embodiments of a thermal control system or various configurations of deposits of nanothermite particles for use in a thermal control system as well as possible uses for a thermal control system. It is to be understood that the various embodiments and use cases are exemplary and are not meant to be limiting.

In all embodiments the composition and configuration of the deposits of nanothermite particles and the type and amount of energy with is created by the energy source to be applied to the nanothermite particles can be selected or altered to achieve temperature control within the thermal control system such that the desired effect of the thermal control system is achieved while limiting adverse effects such as fire, explosions, unwanted phase change, and/or other undesired parameters.

FIG. 5 is a perspective view of two deposits of nanothermite particles 521 and 522 for use in a thermal control system, according to one embodiment. The embodiment of FIG. 5 represents a situation where deposits of nanothermite particles exist as a layer on a surface. The layers may be thin such that the deposits may be described as “two-dimensional”. In the embodiment of FIG. 5 the two deposits of nanothermite particles 521 and 522 are rings. The first deposit 521 is completely within the second deposit 522. The energy source which applies electromagnetic energy to the deposits of nanothermite particles 521 and 522 may be placed below the deposits 521 and 522 and a heat receiving object may be placed on the deposits 521 and 522 such that when the deposits are heated, they transfer heat to the heat receiving object by conduction.

In an alternative embodiment of FIG. 5 the energy source may a be a resistance wire used as a heating element placed beneath the deposits 521 and 522 and which transfers heat to the deposits of nanothermite particles 521 and 522 instead of applying electromagnetic radiation.

The deposits of nanothermite materials may be any number or shape. For example, the deposits may have a geometric pattern or fractal pattern which optimizes the uniformity of heat production over the surface area of the deposits.

In other embodiments the deposits of nanothermite particles may be layered on top of one another with respect to the energy source or the position of the heat receiving object.

The different deposits (or layers) or nanothermite particles may have the same composition of a different composition. The compositions may be homogeneous or heterogeneous.

In embodiments where the layers have different compositions or where a single layer contains a homogeneous mix of nanothermite particles the energy source may be varied to “tune” the magnetic field of the nanothermite particles to control the temperature of the nanothermite particles and the heat which is transferred from the deposit(s) of nanothermite particles to the heat receiving object.

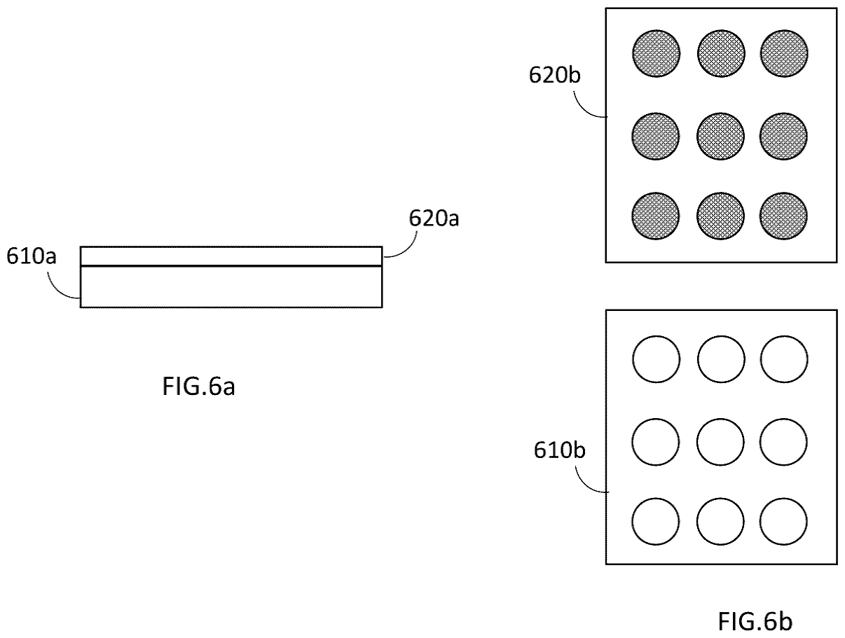

FIGS. 6a and 6b are block diagrams of a configuration for a plurality of energy sources within a structure 610a and a plurality of deposits of thermite particles within a body 620a for use in a thermal control system, according to one embodiment.

FIG. 6a is a side view of the thermal control system illustrating an energy source structure 610a is positioned below the body of nanothermite particles 620a. The energy sources include a plurality of coils within the structure 610a or on a surface of the structure 610a which are each capable of creating a magnetic field which can be applied to a plurality of deposits of nanothermite particles which are embedded within the body 620a or are on a surface of the body 620a.

FIG. 6b is a top view of each layer of the thermal control system shown in FIG. 6a. Each circle within the structure 610b of the energy source represents one of the plurality of coils which produce a magnetic field. Each shaded circle within the body 620b represents a deposit of nanothermite particles. When the structure 610b and the body 620b are stacked each of the plurality of energy sources is positioned adjacent one of the plurality of deposits of nanothermite particles.

Each deposit of nanothermite particles may include multiple layers of nanothermite particles wherein each layer may be different or the same as any other layer. The layers may be stacked on top of each other in the same relation as the structure 610a is stacked with the body 620a. Each deposit of nanothermite particles may include concentric circles of different compositions of nanothermite particles similar to the configuration in FIG. 5.

The plurality of deposits of nanothermite particles may be any shape or size and each deposit may be a different or the same shape of size as other deposits.

In some embodiments, each energy source may be turned off or on individually or may only be turned off or on together. If the energy sources can be turned on/off individually there may be a sequence or pattern which is followed.

In some embodiments, the deposits of nanothermite particles or the body which comprises the deposits may be modular, additive, mountable, embeddable, or otherwise non-permanently affixed to a specific location or object.

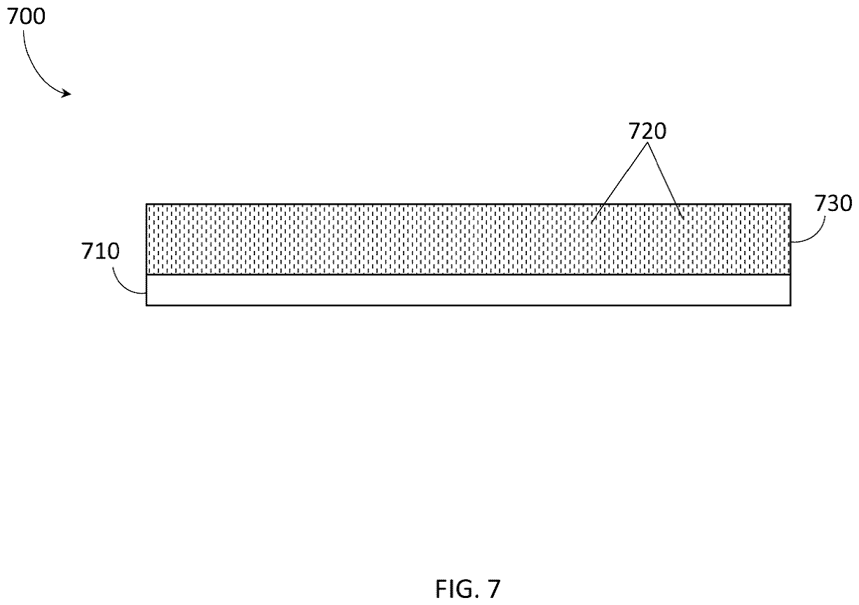

FIG. 7 is a block diagram of a thermal control system 700 including an energy source and a deposit of energetic particles embedded within concrete, according to one embodiment. FIG. 7 represents a possible use of a thermal control system which includes an energy source 710 which is placed below a layer of concrete 730 which has been embedded with nanothermite particles 720. The concrete may be for a road or a sidewalk or any other known use of concrete. When ice is present or expected to occur on the concrete the energy source can be turned on to create a magnetic field which activates the nanothermite particles to heat up the concrete and melt the ice or prevent formation of ice.

In other embodiments, nanothermite particles may be embedded in a similar manner in other materials such as slurries, pastes and/or aggregates or the like.

In other embodiments the energy source may not be positioned under the concrete but rather may be portable, for example, a vehicle containing an energy source may drive over the concrete to activate the nanothermite particles or a removable energy source may be temporarily placed on top of the concrete.

In a specific example, an electric vehicle which charges by induction and therefore is a source of a magnetic field may drive over concrete embedded with nanothermite particles and activate the nanothermite particles to produce heat to heat the concrete.

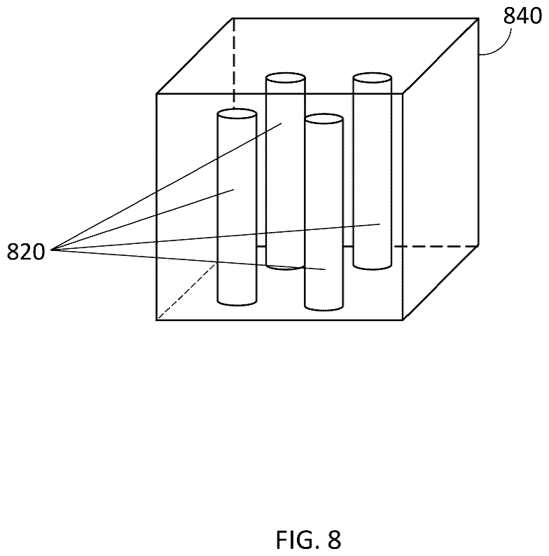

FIG. 8 is a perspective view of a plurality of deposits of thermite particles in the shape of cylinders within a box for use in a thermal control system employing volumetric heating, according to one embodiment. Four cylinders 820 comprising nanothermite particles are within a box 840. When electromagnetic energy is applied to the cylinders 820 they produce heat which can warm the interior volume of the box. In other embodiments a fluid or gas may be passed through the box (wherein the box has openings) to be heated. The fluid or gas may pass through the box by laminar or turbulent flow. The cylinders 820 may be hollow or solid or a combination of the two.

The cylinders 820 may entirely comprise nanothermite particles, may be coated with nanothermite particles, and/or may be embedded with nanothermite particles and otherwise comprise a material which can conduct heat.

The plurality of deposits of nanothermite particles may be any number and any shape. The structure (in this embodiment a box) which includes the interior volume may be any size and shape. Increasing the surface area of the deposits of nanothermite particles may be advantageous to allow for more efficient heating, but must be weighed against the available volume of the box for heating the heat receiving object (e.g., a fluid or gas). An example of system which could employ volumetric heating with deposits of nanothermite particles is a water heater. The water heater could be small like a tankless water heater as the water can be heated up quickly and efficiently to meet a current demand.

Each of the plurality of deposits, or groups of several deposits may be controlled by respective energy sources. That is, for the embodiment of FIG. 8, each cylinder may have a dedicated energy source and each cylinder may be turned on individually. Each cylinder may operate at a different temperature from any other cylinder.

In an embodiment with volumetric heating, the energy source may be within or outside of the volume which is heated.

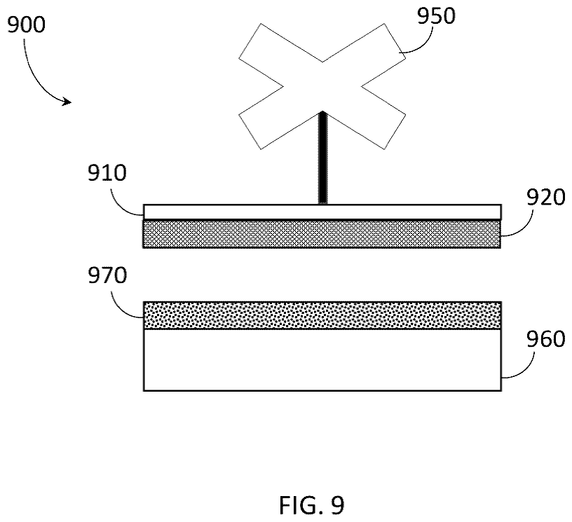

FIG. 9 is a block diagram of a thermal control system 900 on a drone for use in de-icing an object, according to one embodiment. The thermal control system includes an energy source 910 and a deposit of nanothermite particles 920 which are both attached to a drone 950. The drone can carry the energy source 910 and the deposit of nanothermite particles to an object 960 which requires heat to melt a layer of ice 970 on the surface of the object 960. For example, the object 960 may be an airplane and the drone (or multiple drones carrying multiple energy sources and deposits of nanothermite particles) may fly to the airplane to melt the ice. The drones may be autonomous or semi-autonomous and may act together as a fleet.

In other embodiments, a thermal control system with or without drones can be used for de-icing any surface including homes, cars, driveways, roads, sidewalks, buildings, equipment, boats, etc. In other embodiments, nanothermites particles could be embedded into or coat a surface of a brush which is used to clear snow off a vehicle. In other embodiments, a thermal control system may be used to change the viscosity and or surface tension of a fluid (liquid and or gas) on a surface and or material.

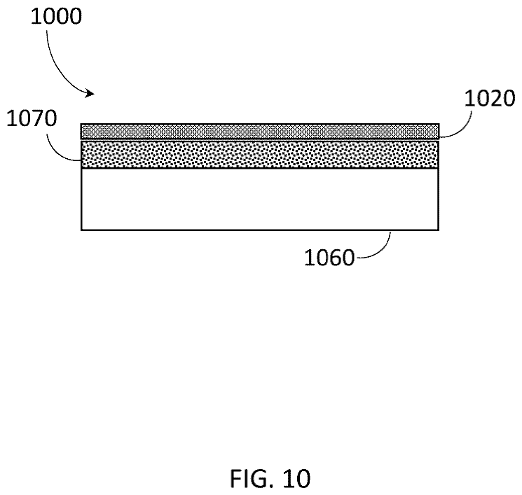

FIG. 10 is a block diagram of part of a thermal control system 1000 wherein thermite particles are deposited directly onto a heat receiving object, according to one embodiment. FIG. 10 shows an object 1060 with a layer of ice 1070 on the surface of the object 1060. Within the embodiment of FIG. 10 a deposit of nanothermite particles 1020 has been sprayed or otherwise deposited onto the surface of the object 1060 which may include being deposited onto some or all of the ice 1070 on the surface of the object 1060. Depositing the nanothermite particles directly onto the heat receiving object (either directly or indirectly in the case of ice on the surface) de-couples the energy source from the nanothermite particles and would necessitate a movable energy source which can be brought to the nanothermite particles. For example, in the above example of an airplane which requires de-icing, a first drone (or set of drones) could deposit the nanothermite particles onto the airplane and a second drone (or set of drones) could bring an energy source to the plane to apply electromagnetic energy to the nanothermite particles. Alternatively, an energy source could be present within the airplane to cause the nanothermite particles to create heat.

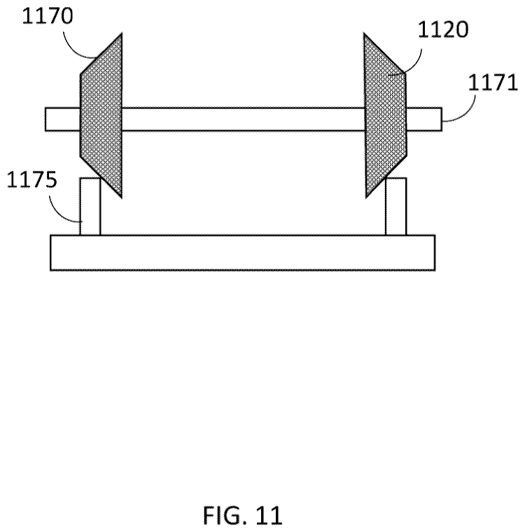

FIG. 11 is a block diagram of a set of train wheels 1170 (only one labelled to reduce clutter) on a train track 1175 wherein a deposit of nanothermite particles 1120 (shading on train wheels 1170) is present on the surface of each of the train wheels (or embedded within the train wheels). The train wheels are connected by a shaft (not labelled). The rest of the train is not shown. The deposits of nanothermite particles 1120 may be caused to heat by an energy source located adjacent the wheels or on the train tracks. As the wheels pass over the train track, the nanothermite particles 1120 can producing heat to prevent ice from forming on the tracks or to melt ice that is already on the train tracks.

In an alternative embodiment to FIG. 11, the train tracks themselves could have nanothermite particles embedded within, or could have a layer of nanothermite particles on the surface of the train tracks. In some embodiments, the nanothermite particles may be sprayed on the tracks as needed.

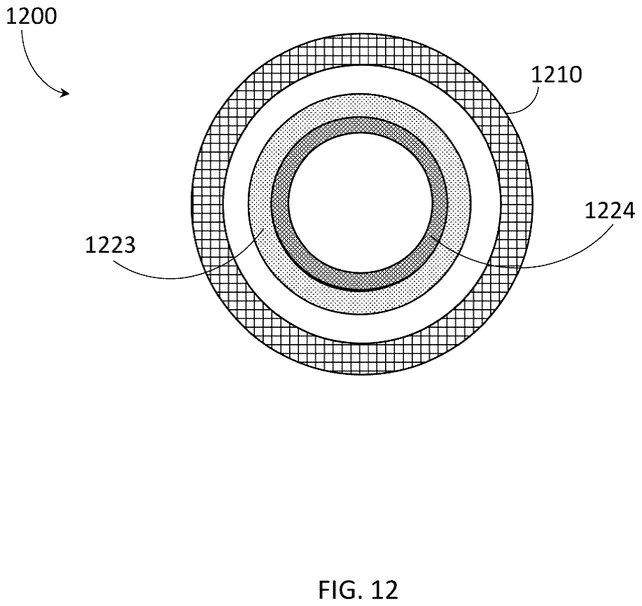

FIG. 12 is a block diagram of thermal control system having an interior into which an object can be placed for heating, wherein the interior is formed within at least one deposit of nanothermite particles, according to an embodiment.

The thermal control system 1200 of FIG. 12 include three concentric hollow tubes. The first outer tube is an energy source 1210, the second tube which is within the first outer tube is a first deposit of nanothermite particles 1223, and the third tube which is inside the second tube is a second deposit of nanothermite particles 1224. An interior of the third tube has a volume which can be volumetrically heated. When the energy source is on and creating electromagnetic energy, the nanothermite particles of the second and third tubes create heat which is transferred into the interior. If an object is placed into the interior then heat may be transferred to the object.

In some embodiments the energy source may not be a tube which is present around the deposits of nanothermite particles but rather may have any structure or form which allows for electromagnetic radiation to be evenly (or unevenly, if desired) applied to the deposits.

In some embodiments there may be additional layers between the energy source and the nanothermite particles, for example a quartz layer.

In some embodiments, there may be only one deposit of nanothermite particles or there may be more than two deposits of nanothermite particles.

In some embodiments, the thermal control system may be a self-sustaining or partially self-sustaining unit which includes a thermal battery and/or thermophotovoltaic system which is powered by the heat from the nanothermite particles and which can then power the energy source.

In some embodiments, the deposits of nanothermite particles may not be hollow tubes within hollow tubes but may be multiple solid cylinders that are positioned within a single tube or other structure and past which a fluid or gas flows to be heated, as partly described above and shown in FIG. 8.

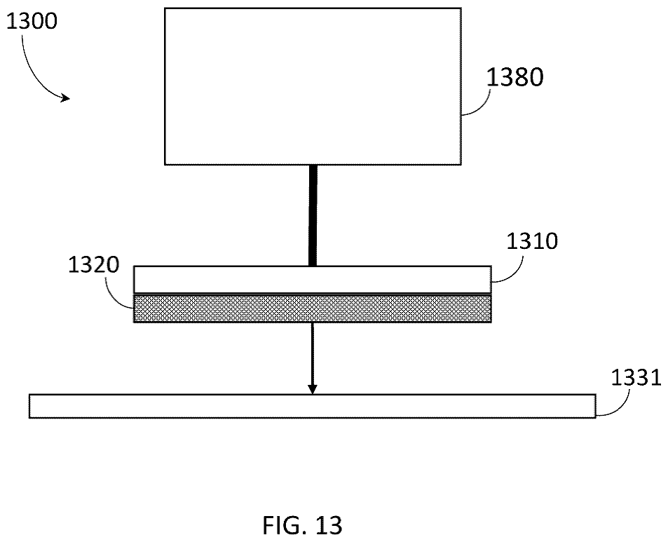

FIG. 13 is a block diagram of a thermal control system 1300 on a spacecraft 1380 for use with applications in space, according to one embodiment. The thermal control system 1300 includes an energy source 1310 and a deposit of nanothermites 1320 attached to the spacecraft 1380.

In the embodiment of FIG. 13, the spacecraft 1380 is landing on the surface of an object (e.g., the Moon, a planet, etc.) and the thermal control system 1300 is used to create a safer landing or take-off area for the spacecraft.

In some embodiments, when energy is applied to the deposit of nanothermites 1320 by the energy source 1310 as the spacecraft is landing (or taking off) the nanothermites 1320 can heat any materials (i.e., regolith) which may be forced off of the surface where the spacecraft is landing (or taking off) and destroy or otherwise affect the materials to prevent dispersal or materials into space or damage of the spacecraft by the materials.

In other embodiments, the spacecraft may spray or otherwise disperse a deposit of nanothermites onto the landing (or take-off) surface and apply energy from the energy source to heat the deposit to create a landing pad.

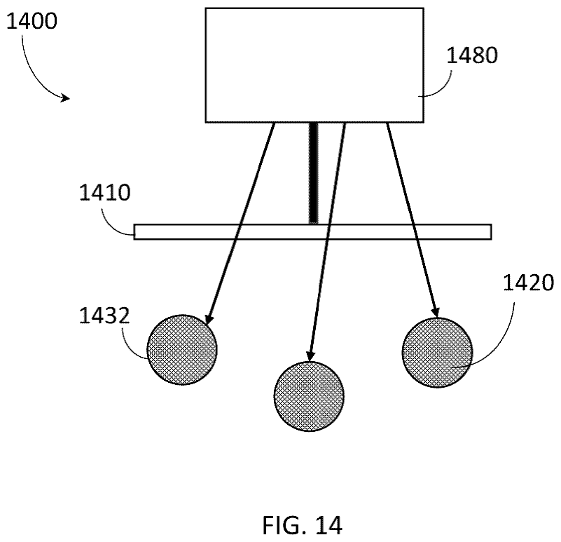

FIG. 14 is a block diagram of a thermal control system 1400 on a satellite 1490 for use with applications in space, according to one embodiment. The thermal control system 1400 of FIG. 14 includes an energy source 1410 attached to the satellite 1490.

In the embodiment of FIG. 14, the thermal control system further includes dispersible nanothermites 1420 that the satellite sprays or otherwise disperses (represented by arrows) onto a surface of three space debris objects 1432. The thermal control system 1400 then applies energy from the energy source 1410 to the nanothermites 1420 on the space debris 1432 to achieve a desired effect. For example, the effect may be that the debris is destroyed or that the debris is moved away from the satellite.

The thermal control system 1400 may be integrated into the satellite 1490 as a subsystem or may be carried by the satellite 1490.

In other embodiments, the nanothermite deposit may be carried with the satellite and not dispersed onto object.

In other embodiments, the thermal control system 1400 may be used to heat an area/volume of space near the satellite 1490.

Herein, several possible use cases and embodiments of a thermal control system using nanothermites have been discussed. These examples are not meant to be limiting. Other possible examples are briefly discussed below:

An energetic particle-based thermal control system may be used in systems and methods for cooking, for example, embedded within or coating ceramic cookware, other cookware, dishware, elements of barbecues, frying pans, pots, utensils, cups, plates, etc.

An energetic particle-based thermal control system can be used for a water heater, as discussed above, or for any other heating system. An energetic particle-based thermal control system can be used for any system which requires ignition. An energetic particle-based thermal control system can be used for power generation and storage of power.

An energetic particle-based thermal control system can be used to drive chemical reactions.

An energetic particle-based thermal control system can be used for other applications in space.

An energetic particle-based thermal control system can be used during production and/or synthesis of products or in recycling systems.

Physical reactions or structural changes which can be caused to occur by a thermal control system may include changes in pressure, viscosity, surface tension, frictional forces, flow, thermochemical reactions, and or the like.

An energetic particle-based thermal control system may be used to create shapes in soft robotics.

An energetic particle-based thermal control system may be used for a rapid expansion device such as an inflatable and/or deployable system.

An energetic particle-based thermal control system may be used for spatial light modulators.

An energetic particle-based thermal control system may be used for ablation, for example in applications such as minimally invasive surgeries or other medical procedures.

An energetic particle-based thermal control system may be used for heating of energetic particles used to augment medical and medical imaging applications. Energetic particles can be applied on a surface and/or biological, organic, and or inorganic material, they may be inductively heated to remove abnormal cells, unwanted tissue, or other undesired particles from an area or volume. The processes may be automated and/or use artificial intelligence and machine learning to support applications and procedures. In other medical application, energetic particles can be used to cleaning and filter of biological materials. In other embodiments, system and methods are adapted for minimally invasive surgeries, for example where inductive heating of energetic particles are used to augment surgery techniques and introduce new capacities to ablative therapy, such as magnets and electromagnets can be used to locally alter the magnetic field heating energetic particles on the surface of and or inside the human body. In other embodiments, magnetic fields can be altered so that the energetic particles undergo a physical change, such as changing shape to puncture through cell walls and microbial biofilms, or may heat and or combust to achieve the same. For heating applications, temperatures up to the Curie Temperature can be used, including the Curie temperate to apply uniform heating across energetic particles. In other implementations, energetic particles may coat surgical instruments to enhance capabilities, for example, during plaque removal using balloon angioplasty the equipment may incorporate energetic particles, where the inflatable balloon is coated with a nanothermite, and then heated to cause a change in the built up plaque, from which the byproducts are removed. Other cases may include coating a stent with nanothermites and inductively heating the stent to melt and remove the plaque. In other embodiments, ablation may be achieved through the combination of nanothermites, metamaterials, and electromagnetic image-guided techniques to heat and destroy unwanted cells or the like. In addition, nanothermites may be arranged in a plurality of geometric shapes.

An energetic particle-based thermal control system may be used for charging batteries, charging electric vehicles, or other forms of power generation.

An energetic particle-based thermal control system may be used as a switch which activates or deactivates a process, reaction, system, etc.

An energetic particle-based thermal control system and/or heating system that may be used in clothing, fabrics, fibres, etc.

In some embodiments, combustion of some or all of the nanothermite deposit within an energetic particle-based thermal control system may be desired. That is, while in most embodiments energy is applied to the nanothermite deposit to maintain the temperature of the deposit at or below the Curie temperature, in some embodiments this may not be the only desired result of applying energy to the nanothermite deposit and additional energy which will cause the nanothermite deposit to at least partially combust may be applied. In these embodiments the results of applying energy to the energetic particles of the nanothermite deposit such that they combust may be to cause propulsion of an object or to generate power.

While the above description provides examples of one or more apparatus, methods, or systems, it will be appreciated that other apparatus, methods, or systems may be within the scope of the claims as interpreted by one of skill in the art.

1-67. (canceled)

68. A thermal control system comprising:
an energy source producing an electric and/or magnetic field;
at least one heat receiving object; and
at least a first deposit of energetic particles deposited at the at least one heat receiving object, wherein the energetic particles comprise a metal and/or a metal oxide, and have an inherent Curie temperature, and wherein upon application of the energy source to the first deposit of energetic particles the energetic particles produce heat and transfer the heat to the at least one heat receiving object to achieve a desired effect.

69. The system of claim 68 wherein the energetic particles are chosen from a group consisting of: metastable intermolecular combustibles, thermites, nanothermites, microthermites, a composition of nanothermites and microthermites, nanoenergetic particles, and nanoenergetic materials.

70. The system of claim 68 wherein the metal is chosen from a group consisting of: aluminum, magnesium, silicon, lithium, boron, and iron.

71. The system of claim 68 further comprising an oxidizer wherein the oxidizer is chosen from a group consisting of: air, water, metal oxides and halogen composites.

72. The system of claim 68 wherein the first deposit of energetic particles are a layer on a surface of the at least one heat receiving object.

73. The system of claim 72 wherein the layer of energetic particles comprises a thermally optimized geometric pattern.

74. The system of claim 68 wherein the first deposit of energetic particles is embedded within the at least one heat receiving object.

75. The system of claim 68 further comprising a second deposit of energetic particles.

76. The system of claim 75 wherein the second deposit of energetic particles has a different Curie temperature than the first deposit of energetic particles.

77. The system of claim 75 wherein the second deposit of energetic particles has the same Curie temperature as the first deposit of energetic particles.

78. The system of claim 75 wherein energy is applied to the second deposit of energetic particles separately from the first deposit of thermite particles.

79. The system of claim 75 wherein energy is applied to the first deposit of energetic particles and the second deposit of energetic particles simultaneously.

80. The system of claim 68 wherein the energy source applies a magnetic field to the at least a first deposit of energetic particles.

81. The system of claim 68 wherein each energetic particle is less than 100 nanometres in size.

82. The system of claim 68 wherein each energetic particle is less than 100 micrometres in size.

83. The system of claim 68 wherein each energetic particle is between 10 and 100 micrometres in size.

84. The system of claim 68 wherein the at least a first deposit of thermite particles includes thermite particles of different sizes.

85. A method of controlled heating of an object, the method comprising:
heating at least a first deposit of energetic particles by applying energy from an energy source to the at least a first deposit of energetic particles, wherein the first deposit of energetic particles has a Curie temperature; and
transferring heat from the at least a first deposit of energetic particles to the object to achieve a desired effect.

86. The method of claim 85 wherein the desired effect occurs at temperatures up to the Curie temperature of the first deposit of energetic thermite particles.

87. The method of claim 85 wherein applying energy from the energy source to the at least a first deposit of energetic particles includes applying an electric and/or magnetic field to the at least a first deposit of energetic particles.
